(19) United States
(12) Patent Application Publication
(10) Pub. No.: US 2006/0080514 A1
(43) Pub. Date: Apr. 13, 2006

(54) Managing shared memory

(75) Inventor: William T. Newport, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/961,739

(22) Filed: Oct. 8, 2004

(51) Int. Cl. G06F 12/14

(52) U.S. Cl. 711/153

(57) ABSTRACT

A method, apparatus, system, and signal-bearing medium that, in an embodiment, receive remote procedure calls that request data transfers between a first memory allocated to a first logical partition and a second memory shared among multiple logical partitions. If the first memory and the second memory are accessed via addresses of different sizes, the data is copied between the first memory and the second memory. Further, the data is periodically copied between the second memory and network attached storage.

### FIELD

An embodiment of the invention generally relates to computers. In particular, an embodiment of the invention generally relates to managing shared memory in the computers.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. Computer technology continues to advance at a rapid pace, with significant developments being made in both software and in the underlying hardware upon which the software executes. One significant advance in computer technology is the development of parallel processing, i.e., the performance of multiple tasks in parallel.

A number of computer software and hardware technologies have been developed to facilitate increased parallel processing. From a hardware standpoint, computers increasingly rely on multiple microprocessors to provide increased workload capacity. Furthermore, some microprocessors have been developed that support the ability to execute multiple threads in parallel, effectively providing many of the same performance gains attainable through the use of multiple microprocessors. From a software standpoint, multithreaded operating systems and kernels have been developed, which permit computer programs to concurrently execute in multiple threads so that multiple tasks can essentially be performed at the same time.

In addition, some computers implement the concept of logical partitioning, where a single physical computer is permitted to operate essentially like multiple and independent virtual computers, referred to as logical partitions, with the various resources in the physical computer (e.g., processors, memory, and input/output devices) allocated among the various logical partitions. Each logical partition executes a separate operating system, and from the perspective of users and of the software applications executing on the logical partition, operates as a fully independent computer.

Logical partitions have applications that typically cache data that changes relatively infrequently for performance reasons. Caching the same data by multiple such partitions and applications running on a single computer system is wasteful of computer resources. A common technique for addressing this problem is the use of shared memory for use by all the partitions. Unfortunately, existing shared memory techniques do not handle replication between computer systems and do not handle the fact that different partitions can use different address sizes.

Without a better way to manage shared memory, customers will not be able to take full advantage of logical partitioning.

### SUMMARY

In various embodiments, a method, apparatus, signal-bearing medium, and computer system are provided that receive remote procedure calls that request data transfers between a first memory allocated to a first logical partition and a second memory shared among multiple logical partitions. If the first memory and the second memory are accessed via addresses of different sizes, the data is copied between the first memory and the second memory. Further, the data is periodically copied between the second memory and network attached storage.

### BRIEF DESCRIPTION OF THE DRAWING

FIG. 1 depicts a block diagram of an example system for implementing an embodiment of the invention.

FIG. 2 depicts a block diagram for the example system showing more detail of selected components, according to an embodiment of the invention.

FIG. 3 depicts a flowchart of example processing for a cache manager bootstrap process, according to an embodiment of the invention.

FIG. 4 depicts a flowchart of example processing for a allocating a memory segment, according to an embodiment of the invention.

FIG. 5 depicts a flowchart of example processing for registering a client with the cache manager, according to an embodiment of the invention.

FIG. 6 depicts a flowchart of example processing for an x-bit client retrieving data from shared memory, according to an embodiment of the invention.

FIG. 7 depicts a flowchart of example processing for a y-bit client retrieving data from shared memory, according to an embodiment of the invention.

FIG. 8 depicts a flowchart of example processing for a x-bit client sending data to shared memory, according to an embodiment of the invention.

FIG. 9 depicts a flowchart of example processing for a y-bit client sending data to shared memory, according to an embodiment of the invention.

FIG. 10 depicts a flowchart of example processing for a client removing data from shared memory, according to an embodiment of the invention.

FIG. 11 depicts a flowchart of example processing for a copying data between systems according to an embodiment of the invention.

### DETAILED DESCRIPTION

In an embodiment, multiple computers are attached via a network, such as network attached storage. Each computer has multiple logical partitions, which use shared memory to transfer data across the network. A cache manager at the computers receives remote procedure calls from clients in the partitions. The remote procedure calls may request data transfers between a first memory allocated to a first logical partition and a second memory shared among multiple logical partitions. The cache manager copies the data between the first memory and the second memory, which may be accessed by addresses of different sizes. Further, the cache manager periodically copies data between the second memory and network attached storage.

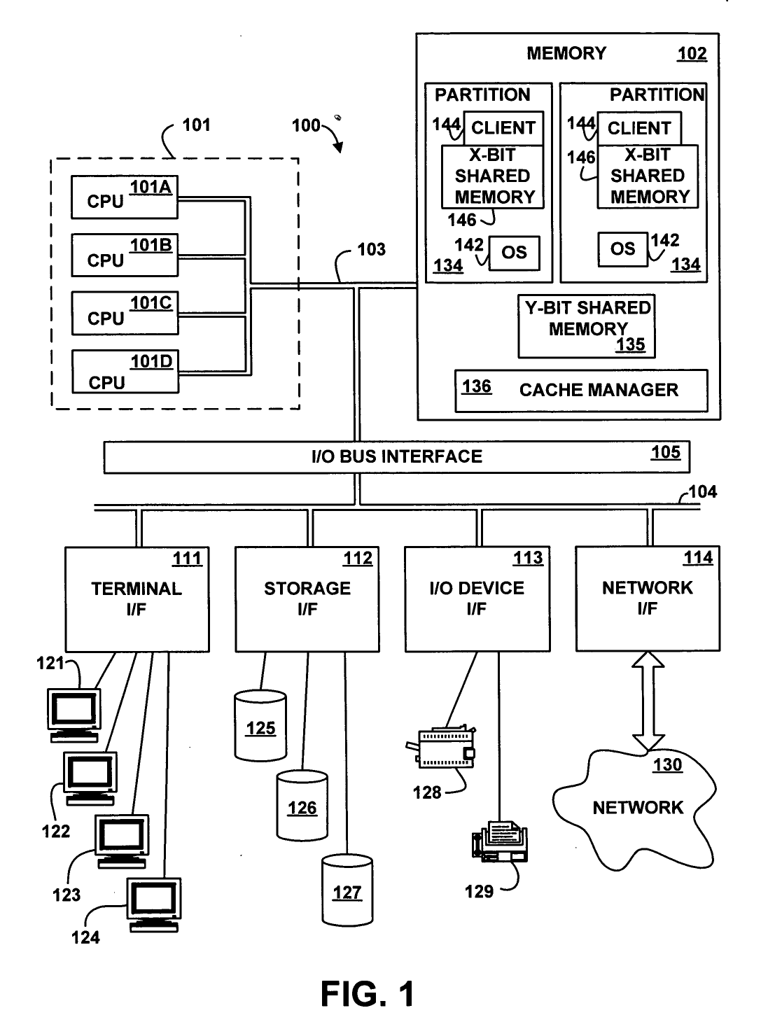

Referring to the Drawing, wherein like numbers denote like parts throughout the several views, FIG. 1 depicts a high-level block diagram representation of a computer system 100 connected to a network 130, according to an embodiment of the present invention. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

Each processor 101 may be implemented as a single threaded processor, or as a multithreaded processor. For the most part, each hardware thread in a multithreaded processor is treated like an independent processor by the software resident in the computer 100. In this regard, for the purposes of this disclosure, a single threaded processor will be considered to incorporate a single hardware thread, i.e., a single independent unit of execution. It will be appreciated, however, that software-based multithreading or multitasking may be used in connection with both single threaded and multithreaded processors to further support the parallel performance of multiple tasks in the computer 100.

In addition, one or more of processors 101 may be implemented as a service processor, which is used to run specialized firmware code to manage system initial program loads (IPLs) and to monitor, diagnose and configure system hardware. Generally, the computer 100 will include one service processor and multiple system processors, which are used to execute the operating systems and applications resident in the computer 100, although other embodiments of the invention are not limited to this particular implementation. In some embodiments, a service processor may be coupled to the various other hardware components in the computer 100 in a manner other than through the bus 103.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor 101. Memory may further be distributed and associated with different CPUs or sets of CPUs, as is known in any of various so-called non-uniform memory access (NUMA) computer architectures.

The memory 102 is illustrated as containing the primary software components and resources utilized in implementing a logically partitioned computing environment on the computer 100, including a plurality of logical partitions 134 managed by an unillustrated task dispatcher and hypervisor. Any number of logical partitions 134 may be supported as is well known in the art, and the number of the logical partitions 134 resident at any time in the computer 100 may change dynamically as partitions are added or removed from the computer 100.

Each logical partition 134 is typically statically and/or dynamically allocated a portion of the available resources in computer 100. For example, each logical partition 134 may be allocated one or more of the processors 101 and/or one or more hardware threads, as well as a portion of the available memory space. The logical partitions 134 can share specific hardware resources such as the processors 101, such that a given processor 101 is utilized by more than one logical partition. In the alternative, hardware resources can be allocated to only one logical partition 134 at a time.

Additional resources, e.g., mass storage, backup storage, user input, network connections, and the I/O adapters therefore, are typically allocated to one or more of the logical partitions 134. Resources may be allocated in a number of manners, e.g., on a bus-by-bus basis, or on a resource-by-resource basis, with multiple logical partitions sharing resources on the same bus. Some resources may even be allocated to multiple logical partitions at a time.

Each of the logical partitions 134 utilizes an operating system 142, which controls the primary operations of the logical partition 134 in the same manner as the operating system of a non-partitioned computer. For example, each operating system 142 may be implemented using the OS/400 operating system available from International Business Machines Corporation, but in other embodiments the operating system 142 may be Linux, AIX, or any appropriate operating system. Also, some or all of the operating systems 142 may be the same or different from each other.

Each of the logical partition 134 executes in a separate, or independent, memory space, and thus each logical partition 134 acts much the same as an independent, non-partitioned computer from the perspective of each client 144, which is a process that hosts applications that execute in each logical partition 134. The clients 144 typically do not require any special configuration for use in a partitioned environment. Given the nature of logical partitions 134 as separate virtual computers, it may be desirable to support inter-partition communication to permit the logical partitions to communicate with one another as if the logical partitions were on separate physical machines. As such, in some implementations it may be desirable to support an unillustrated virtual local area network (LAN) adapter associated with the hypervisor to permit the logical partitions 134 to communicate with one another via a networking protocol such as the Ethernet protocol. In another embodiment, the virtual network adapter may bridge to a physical adapter, such as the network interface adapter 114. Other manners of supporting communication between partitions may also be supported consistent with embodiments of the invention.

Each of the logical partitions 134 further includes an optional x-bit shared memory 146, which is storage in the memory 102 that is allocated to the respective partition 134, and which can be accessed using an address containing a number of bits represented herein as “x.” In an embodiment, x-bit is 32 bits, but in other embodiments any appropriate number of bits may be used. The memory 102 further includes y-bit shared memory 135 and a cache manager 136. Although the cache manager 136 is illustrated as being separate from the logical partitions 134, in another embodiment the cache manager 136 may be a part of one of the logical partitions 134.

The y-bit shared memory 135 is storage in the memory 102 that may be shared among the partitions 134 and which may be accessed via an address containing y number of bits. In an embodiment, y-bit is 64 bits, but in other embodiments any appropriate number of bits may be used. In an embodiment, y and x are different numbers. The cache manager 136 manages the accessing of the y-bit shared memory 135 by the clients 144.

Although the partitions 134, the y-bit shared memory 135, and the cache manager 136 are illustrated as being contained within the memory 102 in the computer system 100, in other embodiments some or all of them may be on different computer systems and may be accessed remotely, e.g., via the network 130. Further, the computer system 100 may use virtual addressing mechanisms that allow the programs of the computer system 100 to behave as if they only have access to a large, single storage entity instead of access to multiple, smaller storage entities. Thus, while the partitions 134, the y-bit shared memory 135, and the cache manager 136 are illustrated as residing in the memory 102, these elements are not necessarily all completely contained in the same storage device at the same time.

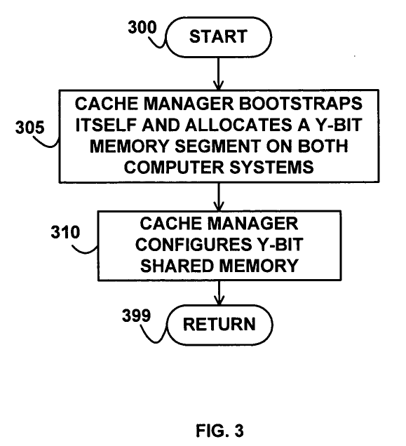

In an embodiment, the cache manager 136 includes instructions capable of executing on the processor 101 or statements capable of being interpreted by instructions executing on the processor 101 to perform the functions as further described below with reference to FIGS. 3-11. In another embodiment, the cache manager 136 may be implemented in microcode or firmware. In another embodiment, the cache manager 136 may be implemented in hardware via logic gates and/or other appropriate hardware techniques.

The memory bus 103 provides a data communication path for transferring data among the processors 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the DASD 125, 126, and 127 may be selectively loaded from and stored to the memory 102 as needed.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in other embodiments the memory bus 103 may comprise multiple different buses or communication paths, which may be arranged in any of various forms, such as point-to-point links in hierarchical, star or web configurations, multiple hierarchical buses, or parallel and redundant paths. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The computer system 100 depicted in FIG. 1 has multiple attached terminals 121, 122, 123, and 124, such as might be typical of a multi-user or mainframe computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

It should be understood that FIG. 1 is intended to depict the representative major components of the computer system 100 at a high level, that individual components may have greater complexity that represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements embodying the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:
(1) information permanently stored on a non-rewriteable storage medium, e.g., a read-only memory device attached to or within a computer system, such as a CD-ROM readable by a CD-ROM drive;
(2) alterable information stored on a rewriteable storage medium, e.g., a hard disk drive (e.g., DASD 125, 126, or 127) or diskette; or
(3) information conveyed to the computer system 100 by a communications medium, such as through a computer or a telephone network, e.g., the network 130, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

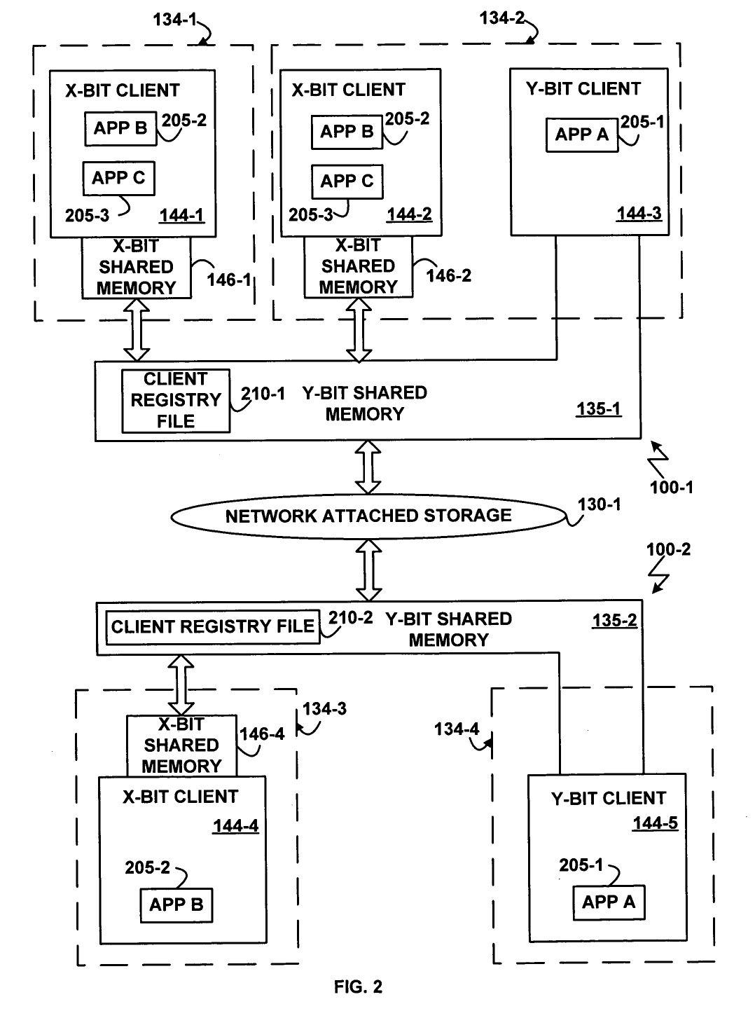

FIG. 2 depicts a block diagram for example computer systems 100-1 and 100-2 connected via network attached storage 130-1, according to an embodiment of the invention. The example computer systems 100-1 and 100-2 are instances of the computer system 100 (FIG. 1). The network attached storage 130-1 is an instance of the network 130 (FIG. 1) and, in various embodiments, is implemented as a SAN (Storage Area Network), an ESS (Enterprise Storage Server), or any other appropriate network.

The example computer system 100-1 includes example logical partitions 134-1 and 134-2, which are instances of the logical partition 134 (FIG. 1). The computer system 100-1 further includes y-bit shared memory 135-1, which is an instance of the y-bit shared memory 135 (FIG. 1). The y-bit shared memory 135-1 includes a client registry file 210-1.

The logical partition 134-1 includes an x-bit client 144-1, which is an instance of the client 144 (FIG. 1) and which includes applications 205-2 and 205-3. The logical partition 134-1 further includes x-bit shared memory 146-1, which is an instance of the x-bit shared memory 146 (FIG. 1) and which is accessed by the x-bit client 144-1.

The logical partition 134-2 includes an x-bit client 144-2, which includes applications 205-2 and 205-3. The logical partition 134-2 further includes x-bit shared memory 146-2, which is an instance of the x-bit shared memory 146 (FIG. 1) and which is accessed by the x-bit client 144-2. The logical partition 134-2 further includes a y-bit client 144-3, which is an instance of the y-bit client 144 (FIG. 1). The y-bit client 144-3 includes an application 205-1.

The example computer system 100-2 includes example logical partitions 134-3 and 134-4, which are instances of the logical partition 134 (FIG. 1). The computer system 100-2 further includes y-bit shared memory 135-2, which is an instance of the y-bit shared memory 135 (FIG. 1). The y-bit shared memory 135-2 includes a client registry file 210-2.

The logical partition 134-3 includes an x-bit client 144-4, which includes the application 205-2. The application 205-2 in the x-bit client 144-4 is sharing data with the application 205-2 in the x-bit client 144-1. The logical partition 134-3 further includes x-bit shared memory 146-4, which is an instance of the x-bit shared memory 146 (FIG. 1) and which is accessed by the x-bit client 144-4. The logical partition 134-4 includes a y-bit client 144-5, which is an instance of the y-bit client 144 (FIG. 1). The application 205-1 in the y-bit client 144-5 is sharing data with the application 205-1 in the y-bit client 144-3.

FIG. 3 depicts a flowchart of example processing for a bootstrap process of the cache manager 136, according to an embodiment of the invention. Control begins at block 300. Control then continues to block 305 where the cache manager 136 bootstraps itself an allocates a segment in the y-bit shared memory 135 for both the computer systems 100-1 and 100-2. Control then continues to block 310 where the cache manager 136 configures the y-bit shared memory 135 to use the network attached storage 130-1. Control then continues to block 399 where the logic of FIG. 3 returns.

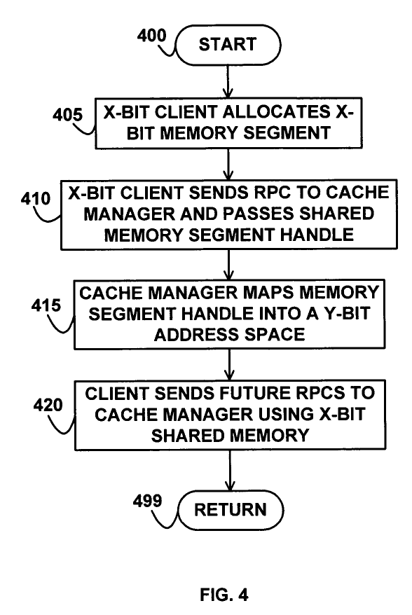

FIG. 4 depicts a flowchart of example processing for allocating a memory segment, according to an embodiment of the invention. Control begins at block 400. Control then continues to block 405 where the x-bit client 144-1, 144-2, or 144-4 allocates a memory segment in the x-bit shared memory 146-1, 146-2, or 146-4, respectively. Control then continues to block 410 where the x-bit client 144-1, 144-2, or 144-4 sends a RPC (Remote Procedure Call) or any other appropriate communication mechanism to the cache manager 136 and passes a handle to the allocated memory segment in the x-bit shared memory 146-1, 146-2, or 146-4, respectively. Control then continues to block 415 where the cache manager 136 maps the passed memory segment handle into the address space of the y-bit shared memory 135-1 or 135-2. In an embodiment, the cache manager 136 also determines that the passed memory segment handle is for the x-bit shared memory 146, that is that the x-bit shared memory and the y-bit shared memory 135 are accessed via addresses of different sizes. Control then continues to block 420 where the x-bit client 144-1, 144-2, or 144-4 sends future RPCs to the cache manager 136 using the x-bit shared memory 146-1, 146-2, or 146-4, respectively. Control then continues to block 499 where the logic of FIG. 4 returns.

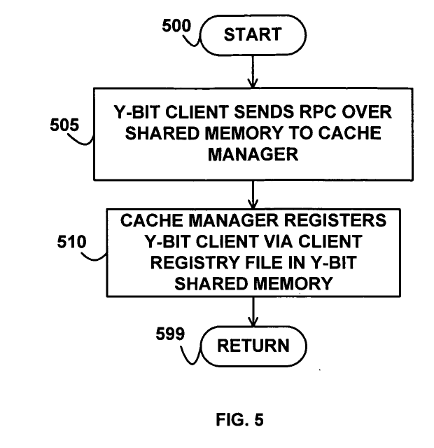

FIG. 5 depicts a flowchart of example processing for registering the y-bit client 144-3 or 144-5 with the cache manager 136, according to an embodiment of the invention. Control begins at block 500. Control then continues to block 505 where the y-bit client 144-3 or 144-5 sends an RPC via the shared memory 135-1 or 135-2, respectively, to the cache manager 136. Control then continues to block 510 where the cache manager 136 registers the y-bit client 144-3 or 144-5 via the client registry file 210-1 or 210-2, respectively, in the y-bit shared memory 135-1 or 135-2. Control then continues to block 599 where the logic of FIG. 5 returns.

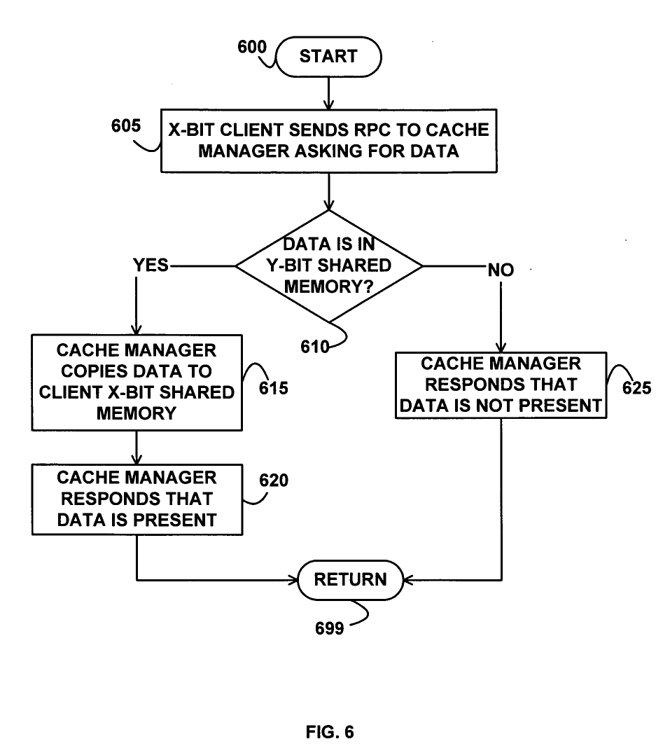

FIG. 6 depicts a flowchart of example processing for the x-bit client 144-1, 144-2, or 144-4 retrieving data from the shared memory 135-1 or 135-2, respectively, according to an embodiment of the invention. Control begins at block 600. Control then continues to block 605 where x-bit client 144-1, 144-2, or 144-4 sends an RPC to the cache manager 136 asking for data. Control then continues to block 610 where the cache manager 136 determines whether the requested data is in the y-bit shared memory 135-1 or 135-2. In an embodiment, the cache manager 136 also determines that the RPC comes from an x-bit client 144, that is that the x-bit shared memory 146 and the y-bit shared memory 135 are accessed via addresses of different sizes.

If the determination at block 610 is true, then the data is in the y-bit shared memory 135-1 or 135-2, so control continues to block 615 where the cache manager 136 copies the requested data from the y-bit shared memory 135-1 or 135-2 to the x-bit shared memory 146-1, 146-2, or 146-4, respectively. Control then continues to block 620 where the cache manager 136 responds to the x-bit client 144-1, 144-2, or 144-4 that the data is present. Control then continues to block 699 where the logic of FIG. 6 returns.

If the determination at block 610 is false, then the data is not in the y-bit shared memory 135-1 or 135-2, so control continues to block 615 where the cache manager 136 responds to the x-bit client 144-1, 144-2, or 144-4 that the data is not present in the shared memory 135-1 or 135-2, respectively. Control then continues to block 699 where the logic of FIG. 6 returns.

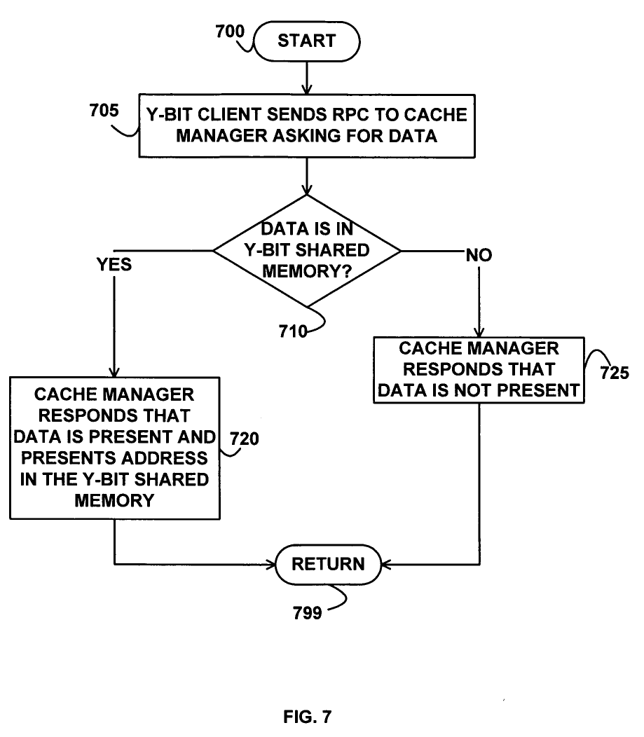

FIG. 7 depicts a flowchart of example processing for the y-bit client 144-3 or 144-5 retrieving data from the y-bit shared memory 135-1 or 135-2, respectively, according to an embodiment of the invention. Control begins at block 700. Control then continues to block 705 where y-bit client 144-3 or 144-5 sends an RPC to the cache manager 136 asking for data. Control then continues to block 710 where the cache manager 136 determines whether the requested data is in the y-bit shared memory 135-1 or 135-2.

If the determination at block 710 is true, then the data is in the y-bit shared memory 135-1 or 135-2, so control continues to block 720 where the cache manager 136 responds to the y-bit client 144-3 or 144-5 that the data is present and gives the address in the y-bit shared memory 135-1 or 135-2 of the data. Control then continues to block 799 where the logic of FIG. 7 returns.

If the determination at block 710 is false, then the data is not in the y-bit shared memory 135-1 or 135-2, so control continues to block 725 where the cache manager 136 responds to the y-bit client 144-3 or 144-5 that the data is not present. Control then continues to block 799 where the logic of FIG. 7 returns.

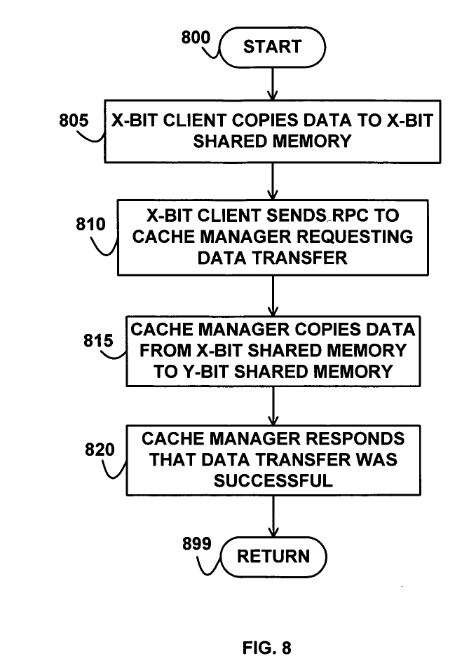

FIG. 8 depicts a flowchart of example processing for the x-bit client 144-1, 144-2, or 144-4 sending data to the y-bit shared memory 135-1 or 135-2, respectively, according to an embodiment of the invention. Control begins at block 800. Control then continues to block 805 where the x-bit client 144-1, 144-2, or 144-4 copies data to the x-bit shared memory 146-1, 146-2, or 146-4, respectively. Control then continues to block 810 where the x-bit client 144-1, 144-2, or 144-4 sends an RPC to the cache manager 136 requesting a data transfer of the data from the x-bit shared memory 146-1, 146-2, or 146-4, respectively. Control then continues to block 815 where the cache manager 136 copies the data from the x-bit shared memory 146-1, 146-2, or 146-4, to the y-bit shared memory 135-1 or 135-2, respectively. In an embodiment, the cache manager 136 also determines that the RPC comes from an x-bit client 144, that is that the x-bit shared memory 146 and the y-bit shared memory 135 are accessed via addresses of different sizes. Control then continues to block 820 where the cache manager 136 responds to the x-bit client 144-1, 144-2, or 144-4 that the data transfer was successful. Control then continues to block 899 where the logic of FIG. 8 returns.

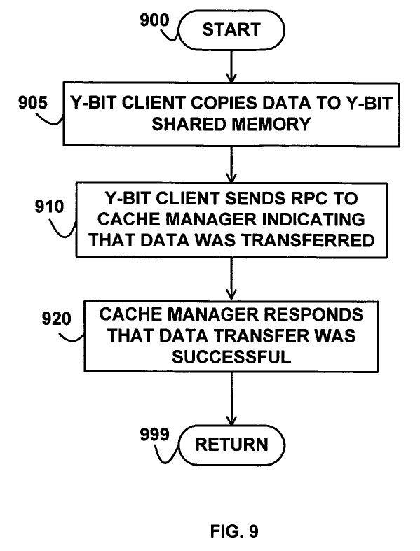

FIG. 9 depicts a flowchart of example processing for the y-bit client 144-3 or 144-5 sending data to the shared memory 135-1 or 135-2, respectively, according to an embodiment of the invention. Control begins at block 900. Control then continues to block 905 where the y-bit client 144-3 or 144-5 copies data to the y-bit shared memory 135-1 or 135-2, respectively. Control then continues to block 910 where the y-bit client 144-3 or 144-5 sends an RPC to the cache manager 136 indicating that the data was transferred. Continues to block 915 where the cache manager 136 responds to the y-bit client 144-3 or 144-5 that the data transfer was successful. Control then continues to block 999 where the logic of FIG. 9 returns.

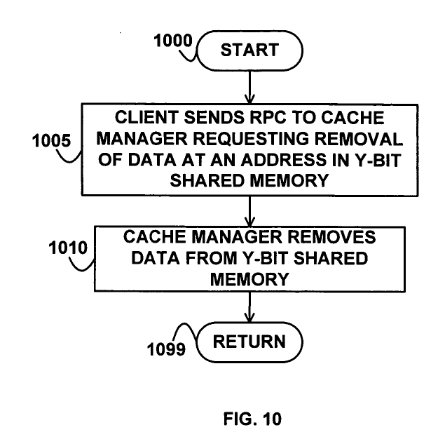

FIG. 10 depicts a flowchart of example processing for a client removing data from the y-bit shared memory 135, according to an embodiment of the invention. Control begins at block 1000. Control then continues to block 1005 where the client 144 sends an RPC to the cache manager 136 requesting removal of data at an address in the y-bit shared memory 135. Control then continues to block 1010 where the cache manger 136 removes the requested data from the y-bit shared memory 135. Control then continues to block 1099 where the logic of FIG. 10 returns.

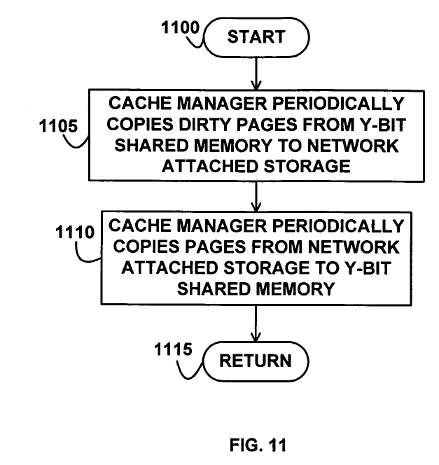

FIG. 11 depicts a flowchart of example processing for a copying data between the computer systems 100-1 and 100-2 according to an embodiment of the invention. Control begins at block 1100. Control then continues to block 1105 where the cache manager 136 periodically copies dirty pages from the y-bit shared memory 135-1 or 135-2 to the network attached storage 130-1. Control then continues to block 1110 where the cache manager 136 periodically copies pages from the network attached storage 130-1 to the y-bit shared memory 135-1 or 135-2. Control then continues to block 1115 where the logic of FIG. 11 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
copying data between a first memory allocated to a first logical partition and a second memory shared among a plurality of logical partitions, wherein the first memory and the second memory are accessed via addresses of different sizes.

2. The method of claim 1, further comprising:
periodically copying the data from the second memory to network attached storage.

3. The method of claim 1, further comprising:
periodically copying the data from network attached storage to the second memory.

4. The method of claim 1, further comprising:
mapping a memory segment handle from the first memory into the second memory.

5. An apparatus comprising:
means for receiving a remote procedure call that requests a data transfer between a first memory allocated to a first logical partition and a second memory shared among a plurality of logical partitions, wherein the first memory and the second memory are accessed via addresses of different sizes; and
means for copying the data between the first memory and the second memory.

6. The apparatus of claim 5, further comprising:
means for periodically copying the data from the second memory to network attached storage.

7. The apparatus of claim 5, further comprising:
means for periodically copying the data from network attached storage to the second memory.

8. The apparatus of claim 5, further comprising:
means for mapping a memory segment handle from the first memory into the second memory.

9. A signal-bearing medium encoded with instructions, wherein the instructions when executed comprise:
receiving a remote procedure call that requests a data transfer between a first memory allocated to a first logical partition and a second memory shared among a plurality of logical partitions;
determining whether the first memory and the second memory are accessed via addresses of different sizes; and
copying the data between the first memory and the second memory if the determining is true.

10. The signal-bearing medium of claim 9, further comprising:
periodically copying the data from the second memory to network attached storage.

11. The signal-bearing medium of claim 9, further comprising:
periodically copying the data from network attached storage to the second memory.

12. The signal-bearing medium of claim 9,
mapping a memory segment handle from the first memory into the second memory.

13. A computer system having a plurality of logical partitions, the computer system comprising:
a processor; and
memory encoded with instructions, wherein the instructions when executed on the processor comprise:
receiving a remote procedure call that requests a data transfer between a first memory allocated to a first logical partition and a second memory shared among the plurality of logical partitions,
determining whether the first memory and the second memory are accessed via addresses of different sizes, and
copying the data between the first memory and the second memory if the determining is true.

14. The computer system of claim 13, wherein the instructions further comprise:
periodically copying the data from the second memory to network attached storage.

15. The computer system of claim 13, wherein the instructions further comprise:
periodically copying the data from network attached storage to the second memory.

16. The computer system of claim 13, wherein the instructions further comprise:
mapping a memory segment handle from the first memory into the second memory.

17. A method for configuring a computer, wherein the method comprises:
configuring the computer to copying data between a first memory allocated to a first logical partition and a second memory shared among a plurality of logical partitions, wherein the first memory and the second memory are accessed via addresses of different sizes.

18. The method of claim 17, further comprising:
configuring the computer to periodically copy the data from the second memory to network attached storage.

19. The method of claim 17, further comprising:
configuring the computer to periodically copy the data from network attached storage to the second memory.

20. The method of claim 17, further comprising:
configuring the computer to map a memory segment handle from the first memory into the second memory.
